(19) United States
(12) Patent Application Publication
(10) Pub. No.: US 2004/0181426 A1
(43) Pub. Date: Sep. 16, 2004

(54) Process for registering and deregistering products and their colored settings

(76) Inventors: Dorothy Rose, Dormagen (DE); Edgar Ostlinning, Krefeld (DE)

Correspondence Address: BAYER MATERIAL SCIENCE LLC, 100 BAYER ROAD, PITTSBURGH, PA, 15205, US

(21) Appl. No.: 10/794,862

(22) Filed: Mar. 5, 2004

(30) Foreign Application Priority Data
Mar. 11, 2003 (DE) 10310415.1

(51) Int. Cl. G06F 17/60

(52) U.S. Cl. 705/1

(57) ABSTRACT

Relative to administrative processes within business organizations (such as world wide corporations), the present invention provides a method of registering and/or deregistering a product (e.g., a new product, such as a thermoplastic composition or article having a particular color or colors associated therewith). More particularly, the product registration method of the present invention involves the steps of: (a) inputting registration data from a location; (b) generating a product electronic folder for the product; (c) generating a registration process electronic folder for the registration process, wherein the registration process electronic folder is allocated to the product electronic folder; (d) selecting a workflow, according to the registration data, from a quantity of predetermined workflows; (e) creating registration documents according to the selected workflow; (f) storing the registration documents in the registration process electronic folder; (g) registering a color for the product; and (h) accessing a database having a plurality of locations, for purposes of assigning a color number for the registered color. Also described is a computer program and computer system for performing the registration/deregistration process.

### CROSS REFERENCE TO RELATED PATENT APPLICATION

The present patent application claims the right of priority under 35 U.S.C. §119 (a)-(d) of German Patent Application No. 103 10 415.1, filed Mar. 11, 2003.

### FIELD OF THE INVENTION

The present invention relates to a process and to a computer system for registering and/or deregistering products, and their colored settings.

### BACKGROUND OF THE INVENTION

Various administrative processes for registering and deregistering new products and the authorization thereof are known. The appropriate registration or deregistration request typically passes through the various levels of a company, which each check the registration or deregistration request, possibly contribute information and optionally grant their consent. In particular in companies operating worldwide and companies with a large product portfolio, authorization processes of this type are complex and involve a relatively large number of employees.

A problem known per se in registration and authorization processes of this type is that the time required for this purpose is quite long, and the internal transaction costs associated therewith are typically high. Excessive amounts of time associated with the registration process may, in particular, extend the time-to-market, and this may have adverse effects on the competitive position of the company or organization. Excessive amounts of time associated with deregistering products may also lead to inflated portfolios, and this may have an adverse effect on the cost situation of the company or organization.

A particular problem which may arise in this connection is the registration and authorization of product variants which vary in terms of color with respect to a basic product.

It is known per se to clearly identify a certain color with a certain number. A color number of this type is then used, for example, for access to the corresponding color in a color catalogue or as a code for access to information relating to the color in a database.

This information relating to the color may be, for example, the color coordinates of the color and/or further information, such as customer information, information relating to production, in particular relating to the compounding of a polymer, in order to produce a plastics material with the desired color.

Here, the color number is different from the color coordinates of the associated color: the color number is used merely to identify the color in a quantity of colors, whereas the color coordinates indicate the position of a color in a color space. CIELAB or a different color coordinate system may, for example, be used here.

Products made of plastics material typically have an immense number of different colors associated therewith. It is particularly important here that a certain product always have the same color in order to ensure a consistent appearance. Such a color of a certain product is assigned a color number for this purpose. As a result of the large number of products and different colors there is a problem in efficiently assigning color numbers according to a uniform system in order to ensure clear allocation of color numbers and color.

### SUMMARY OF THE INVENTION

The object of the invention is therefore to provide an improved process for registering and deregistering a product and associated colors, and a corresponding computer program product and computer system.

In accordance with the present invention, there is provided a process for registering a product comprising:

(a) inputting registration data from a location;

(b) generating a product electronic folder for the product;

(c) generating a registration process electronic folder for the registration process, wherein the registration process electronic folder is allocated to the product electronic folder;

(d) selecting a workflow, according to the registration data, from a quantity (or plurality) of predetermined workflows;

(e) creating registration documents according to the selected workflow;

(f) storing the registration documents in the registration process electronic folder;

(g) registering a color for the product by means of,

(i) registering a color registration process electronic folder for the color registration process, which is allocated to the product electronic folder,

(ii) generating color registration documents according to a color registration workflow, and

(iii) storing the color registration documents in the registration process electronic folder; and

(h) accessing a database having a plurality of locations, for purposes of assigning a color number for the registered color by means of,

(I) allocating a number space to each location, provided that a free number space remains, and

(II) carrying out the following steps to generate a new entry in the database from one of the locations:

(i) removing a number from the number space of the location,

(ii) storing the entry in the database with the number as a code, and

(iii) replacing the removed number with a number from the free number space in the number space of the location.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions used in the specification and claims are understood as modified in all instances by the term “about.”

### BRIEF DESCRIPTION OF THE DRAWING FIGURES

FIG. 1 is a representative flow diagram of an embodiment of a process according to the invention for registering a product;

FIG. 2 is a representative flow diagram for registering a color variant of the product;

FIG. 3 is a representative flow diagram of an embodiment of a process according to the invention for establishing color numbers, and generating a corresponding database for storing information allocated to the color numbers;

FIG. 4 is a representative block diagram of a color number database of a central server;

FIG. 5 is a representative block diagram of an embodiment of a database for storing information allocated to color numbers; and

FIG. 6 is a representative block diagram of an embodiment of a computer system according to the invention with replicas of color number databases.

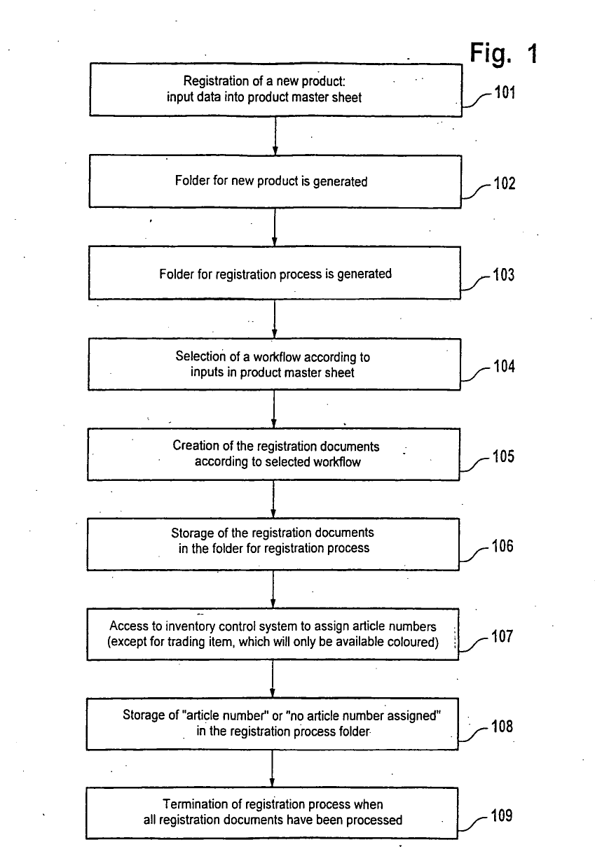

In FIGS. 1 through 6, like reference numerals designate the same operations, modules and components.

### DETAILED DESCRIPTION OF THE INVENTION

The present invention allows quick, efficient and reliable completion of a registration or deregistration and authorization process for a new product and of color variants of a new product. This is achieved by a spatially distributed information technology system which covers various locations of a company. A registration procedure may be started from any of the locations.

A workflow is selected from a predetermined quantity of workflows depending on the type of registered or deregistered product, the location from which the registration or deregistration is input and the target markets for the product. Registration or deregistration documents are generated according to the selected workflow and these are addressed to the relevant employees in the company. These registration or deregistration documents are stored in an electronic folder for the registration or deregistration procedure which is allocated to an electronic folder for the product.

The employees concerned are instructed with regard to authorization steps to be carried out and the termination thereof on the basis of the registration or deregistration documents. As soon as all registration or deregistration documents have been sufficiently completely processed, the registration or deregistration of the product is concluded.

It is particularly advantageous that, based on the newly registered product, color variants -of this product may be efficiently registered. For this purpose, a simplified registration procedure is run through, based on the previously registered product. This procedure involves the assignment of a color number for the color variant of the product.

It is also particularly advantageous that, based on the registered products or product color variants, deregistration may be efficiently carried out.

The invention allows color numbers for color variants to be decentrally assigned, wherein the consistency of the assignment of color numbers overall is also ensured. This is particularly significant for concerns operating worldwide, as color numbers may be assigned independently of one another at the individual locations in order, for example, to clearly identify worldwide colors desired by different customers at different locations for different products.

According to a preferred embodiment of the invention a color number comprises two different groups of numerals. The first group of numerals determines the color type. The color type is composed of the color group and the chromaticity. For example, the first numeral may specify the color group, wherein, for example, “0” indicates the color white and “9” the color black. The second numeral which establishes the chromaticity, may, for example, contain the information as to whether it is a transparent or an opaque color. The first two numerals are established in this embodiment therefore by the fundamental properties of the color itself. This is a crude classification which may be carried out without the aid of technical means, such as color-measuring instruments, for example.

The second group of numerals contains a number from a number space. These may substantially be consecutive numbers.

According to a preferred embodiment of the invention the process for selecting this number is as follows: firstly, an initial number space is allocated to each location at which color numbers are defined. These initial number spaces are not overlapping. Furthermore, a free number space is available which is identical for all locations. To define a new color number at a certain location the number space allocated to the relevant location is then accessed in order to remove a number from there. For example, the smallest number of the number space may always be removed to thus arrive at consecutive numbers in the second group of numerals.

Once one number has been removed from the number space of a location it is replaced by a number from the free number space. According to a preferred embodiment of the invention the process here is such that the individual locations are cyclically interrogated in order to establish whether a number has been removed from the respective number space there.

If this is the case a number is removed from the free number space for the relevant location and this number removed from the free number space is allocated to the number space allocated to the location. The number previously removed from the number space of the location is replaced by the number removed from the free number space by this allocation. The number removed from the free number space is then no longer available for removal from the free number space. This free number is “used” for the other locations. A particular advantage in this connection is that color numbers are decentrally defined which are clear and that there is also effective use of a predetermined number space.

According to a further preferred embodiment of the invention a distributed color number database is used for assigning color numbers. The color number database contains a number space allocated to the relevant location for each of the locations. The color number database also contains a free number space.

The free number space is not allocated to any of the locations. There is a server at each of the locations, on which at least a partial replica of the color number database is stored. The partial replica contains at least the number space allocated to the relevant location. However, a complete replica may also be used at all locations. A replication mechanism known per se from “Lotus Notes” is preferably used for information distribution and for adjusting and synchronising the contents of “copies” of the color number database to the various spatially distributed servers.

During the replication process the replicas exchange only the temporary changes in data with the source, which changes have taken place since the last adjustment or last replication.

According to a further preferred embodiment of the invention there is a central server at one of the locations which is solely authorised to access the free number space. The central server has a computer program for cyclical interrogation of the replicas of the color number database stored on the servers of the individual locations as to whether a number has been removed, i.e. “used”, from the number space of the relevant location in a replica.

If such an interrogation indicates that this is the case the central server accesses the free number space in order to remove a free number from it. This number removed from the free number space is then used as a replacement for the number previously removed from the number space of the location. The number space of this location is thus replenished again. The process is carried out in the same way for all locations.

According to a further preferred embodiment of the invention information relating to the color clearly identified by the color number is stored in a separate database or likewise in the color number database under the relevant color number. This information may, for example, be the color coordinates of the color in a certain color coordinate system, customer information or information with respect to the compounding of a plastics material for the production of the desired shade. The relevant information may be reliably accessed using a color number as the code owing to the clear selection of the color numbers at the various locations.

According to a further preferred embodiment of the invention a replica of the database with the color numbers and the information allocated to the color numbers is available on each server of the computer system according to the invention, so this information may be directly accessed at any location without a remote interrogation of the data being necessary. This has the particular advantage that, for example, in event of a customer request for a plastics material of a certain color a check may easily be made as to whether this color is already available. For this purpose, the customer may, for example, indicate the color coordinates of the desired color. A database search is then carried out in the replica using these color coordinates in order to establish whether a color number for a plastics material with the same or the most similar color coordinates possible already exists.

Preferred embodiments of the invention will be described in more detail hereinafter with reference to the drawings.

FIG. 1 shows a flow diagram for registering a new product. For this purpose, registration of the new product is initiated from one location in step 101. For this purpose, product registration data is input into a product master sheet. The following data for example is entered into the product master sheet. The type of product, i.e. whether it is a laboratory product, test product, trading item or intermediate product, the product name, product manager, employees to be involved, region to which the location, from which the registration takes place, belongs, name of the initiator of the registration and further data.

After inputting the data, an electronic folder for the new product is set up in step 102. In step 103 a sub-folder is set up within this electronic folder for the new product. This sub-folder relates to the registration process for the new product.

A workflow for the registration and authorization procedure is selected in step 104. A workflow is selected here according to the inputs into the product master sheet. For example, the input fields in the product master sheet which are decisive for the selection of the workflow are configured with a pull-down or pop-up menu which allows only a certain number of predetermined input possibilities. A specific workflow is stored for any selection combination possibility from this pull-down or pop-up menu. Therefore, in step 104 the workflow corresponding to the selection of inputs from the pull-down or pop-up menus is selected.

In step 105 the instances of registration documents are created according to the previously selected workflow and are stored in the sub-folder in step 106.

The employees involved preferably receive a bookmark leading to the sub-folder for the registration process. This facilitates access for the employees involved to the registration documents to be processed.

In step 107 there is also access to an inventory control system, for example an SAP system, for assigning an article number to the product.

When registering the new product the process is preferably such that it is a colorless product. This applies, in particular, to trading items as these are probably to be produced in many different colors. Assignment of an article number for a trading item may, however, be dispensed with if the trading item is only to come on the market as a colored product. The expenditure for assigning an article number to the product may be saved in this case.

In step 108 the article number assigned in step 107 is stored in the sub-folder for the registration process. If an article number is not necessary as the trading item is only to be obtained as a colored product, “no article number assigned” is instead to be stored as a dummy character.

The registration process for the product is terminated in step 109 when all registration documents have been processed.

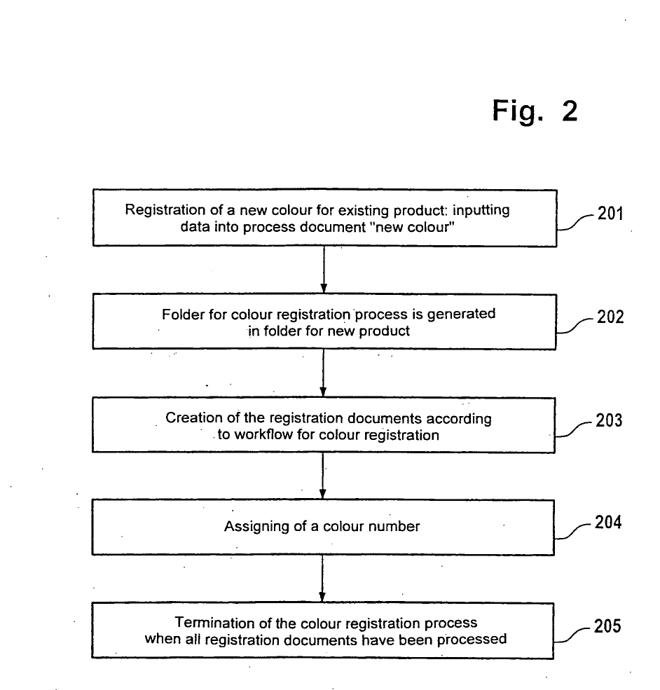

FIG. 2 shows the procedure for registration of a new color variant for an already previously registered product. For this purpose, color registration data is input in step 201 into a process document “new color”. The registration data for the new color contains, for example, the color coordinates of the color.

A new sub-folder is then generated in step 202 for the color registration process in the electronic folder of the basic product (cf. step 102 of FIG. 1).

The registration documents are generated in step 203 according to a predetermined workflow for the color registration and are stored in the sub-folder for the color registration process.

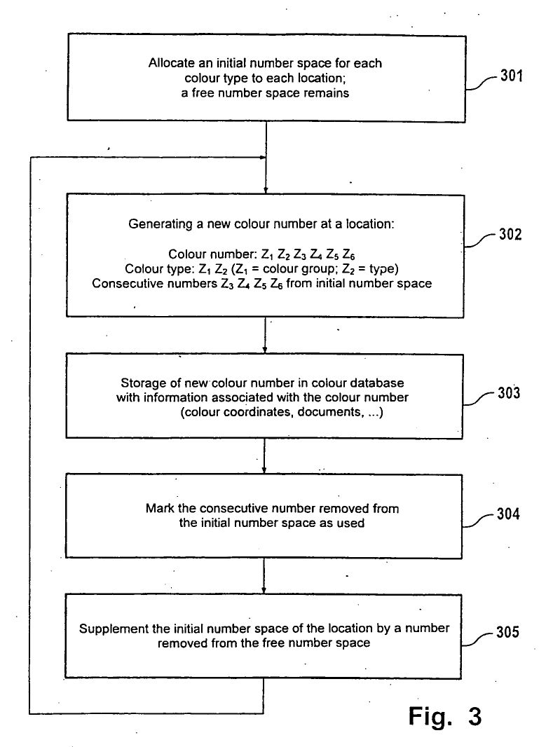

In step 204 a color number is assigned to the color variant of the product. The manner of assigning the color number is described in more detail with reference to FIG. 3 to 6.

The color registration process is terminated in step 205 as soon as all registration documents have been sufficiently completely processed.

Implementation of the registration process described with reference to FIGS. 1 and 2 with a Lotus Notes application is particularly advantageous. In this case the registration documents are Lotus Notes documents.

FIG. 3 shows a flow diagram for the decentral assignment of color numbers to various locations (cf. step 204 of FIG. 2).

A company with global operations in the chemical industry, for example, has branches at various physically separate locations which receive customers' demands for the production of products with a certain color specified by the customer. When a customer directs such a request to a specific location it is necessary for this location to assign a clear company-wide color number to the color specified by the customer.

For this purpose, a dedicated number space is firstly allocated to each of the locations in step 301. The individual number spaces of the locations are not overlapping. This may take place in such a way that there is not just one number space allocated to each location, rather a number space of this type for each type of color.

There is also a free number space which is allocated to none of the locations. There is a free number space for each of the color types when assigning number spaces to each color type. The number spaces allocated to the locations and the free number space for one color type preferably form a continuum.

In step 302 a customer request is directed to a location. A color number for the color specified by the customer then has to be assigned at this location. In the example examined here, a color number always has six numerals Z1, Z2, Z3, Z4, Z5 and Z6. The first two numerals Z1 and Z2 indicate the type of color. Z1 indicates to which color group the color specified by the customer belongs. Here, for example, Z1=0 stands for white and Z1=9 for black.

The numeral Z2 specifies the type of color, in other words for example Z2=0 means transparent and Z2=1 means opaque. The first two numerals of the color number therefore result in the example examined here (i.e., directly from properties of the specified color).

The further numerals Z3, Z4, Z5 and Z6 are found by taking a number from the number space, allocated to the location, of the type of color of the specified color.

In step 303 the new color number is stored together with the information allocated to the color number, such as the color coordinates and/or further documents, in the color database.

In step 304 the number taken from the number space in step 302 is marked as being used. This number is then replaced in the number space by a number taken from the free number space. The number space from which a number was previously removed in step 302 is thus replenished again. As long as there are enough free numbers it is thus ensured that there are always enough numbers in the corresponding number space in event of subsequent further new colors of this color type.

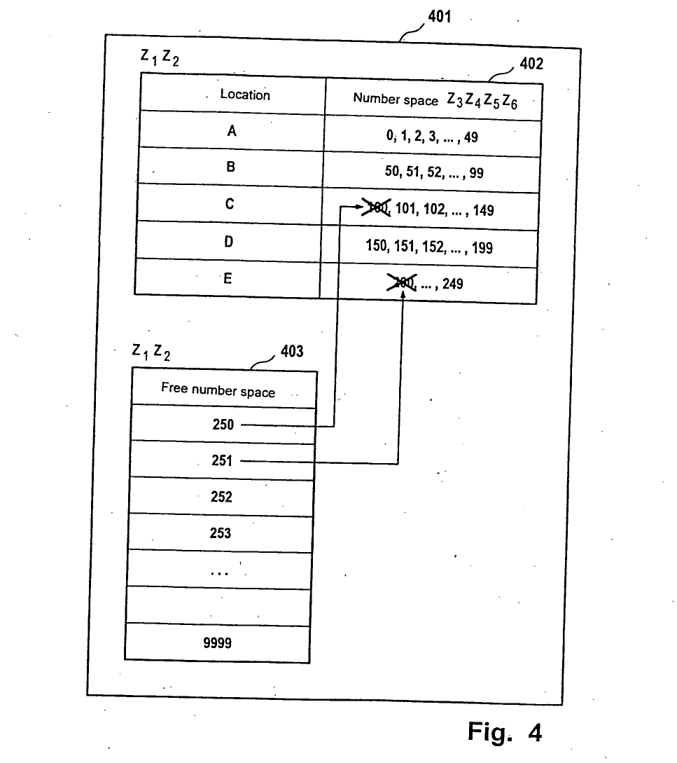

FIG. 4 shows the structure of a color number database 401 stored on a central server. The color number database has a memory sector 402 in which a number space Z3, Z4, Z5, Z6 is allocated to each location A, B, C, D and E and, more precisely, for each color type Z1, Z2.

For example the number space from 0 to 49 is allocated to the location A for a certain color type Z1, Z2. A contingent of fifty numbers is accordingly allocated to each of the further locations in a corresponding number space for each color type. This means that one hundred number spaces with fifty numbers each are allocated to each location and, more precisely, according to the one hundred possible color types Z1, Z2.

Furthermore, the color number database 401 has a memory sector 403 containing a free number space for each color type Z1, Z2. In the embodiment examined of FIG. 4 the free number space for each color type Z1, Z2 ranges from 250 to 9999.

If, for example, at location C a color number has to be determined for a color specified by the customer the color type of the color is firstly ascertained. From this result the numerals Z1 and Z2 and therefore also the number space allocated to this color type at location C. The smallest number is then removed from this number space—in this example the number 100. This number is marked as “used” in the number space. The numeral sequence Z3, Z4, Z5, Z6 therefore results from the number 100 for the color number: 0100.

To replace the used number 100 of the number space of the location C for the color type Z1, Z2 access is made to the free number space of the same color type and a number removed from there. In the example examined the smallest available number of this free number space is accessed, in other words the number 250. This number replaces the number 100, which has previously been “used”, in the number space of the location C for this color type. This number space is thus replenished again and the free number space reduced by one number.

Thereafter or simultaneously a color number is also ascertained at location E for a color of the same color type. For this purpose, access is again made to the number space allocated to location E for this color type and the smallest number of the number space removed. In the example examined this is the number 200.

The numeric string 0200 results herefrom. The number 200 is then marked as used. To replace the used number 200 of this number space access is again made to the free number space of the memory sector 403 of this color type to remove the smallest number still available from this number space. This is the number 251 which then takes the place of the used number 200 in the number space of location E.

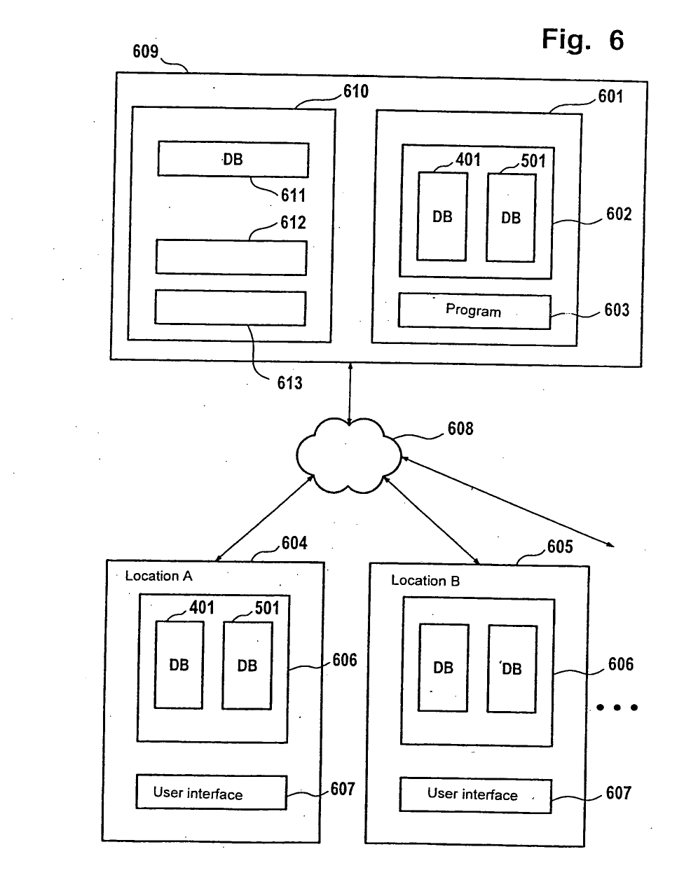

All requests regarding the locations according to color numbers are dealt with in this way, wherein the requests may be processed decentrally. The decentral organisation of the requests by means of an appropriate computer system is described in more detail below with reference to FIG. 6.

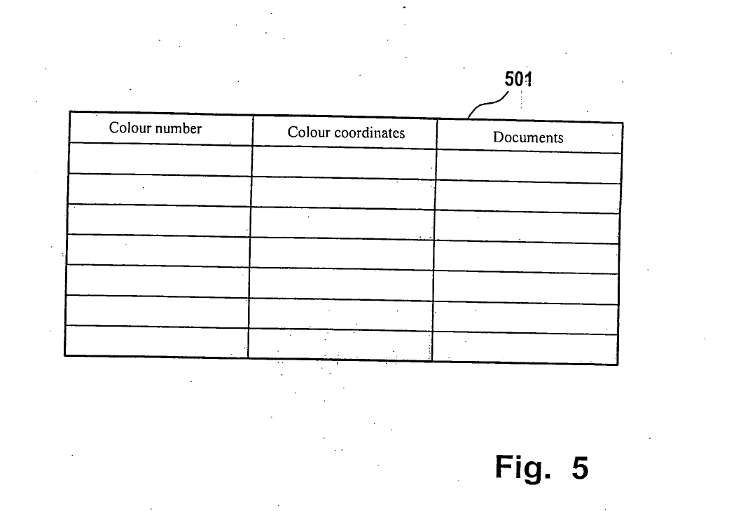

FIG. 5 shows a color database 501 in which the color coordinates and further documents relating to a color identified by the color number are stored under a color number. The color database 501 is successively filled by memory operations carried out from the individual locations. It is thus possible in the event of a customer request at one of the locations to firstly check whether there is already a color number for the color desired by the customer with the given color coordinates. The labour for assigning redundant color numbers may thus be avoided.

FIG. 6 shows a block diagram of a divided computer system. The computer system comprises a central server 601. A database 602 containing the color number database 401 (cf. FIG. 4) and the color database 501 (cf. FIG. 5) is stored in the server 601.

The central server 601 also has a program 603 for the cyclical interrogation of servers 604, 605, . . . .

The server 604 is at location A. The server 604 has a replica 606 of the database 602 and a user interface 607. A user may access the replica 606 via the user interface 606 to carry out an interrogation, for example, in the database 501 or to generate a new color number.

The servers 605, . . . at the further location(s) B, . . . are constructed according to the same principles. Each of the servers at the individual locations as a replica 606 of the database 602.

The servers 604, 605 . . . and the central server 601 may communicate via a computer network 608, for example the Internet. The replicas 606 and the database 602 may also merge in this manner. A replication mechanism known per se, which is used in Lotus Notes, is preferably used here.

The program 603 cyclically interrogates the individual servers 604, 605, . . . , for example every three hours. The program 603 interrogates the color number database 401 in each of the servers 604, 605, . . . as to whether a number is marked as used in the color number database 401.

If this is the case the program 603 ascertains a free number for the used number from the corresponding free number space of the relevant color type (cf. memory sector 403 of FIG. 4) which is allocated to the number space with the used number as a replacement. This number space is thus replenished again.

The central server 601 for assigning the color numbers is part of a computer system 609 which comprises a further central server 610. The central server 610 has a database 611 for storing product and color registration documents which are each allocated to specific employees. The relevant documents in the database 611 may be accessed from the various locations A, B . . . Lotus Notes technology may also be used here, in other words there may be local replicas of the database 611 at the servers 604, 605, . . . of the different locations.

The central server 610 also has a program 612 for carrying out the registration process, as has been described above, for example with reference to FIGS. 1 and 2. The program 612 therefore sets up an electronic folder for a newly registered product in the database 611 and electronic sub-folders for the registration procedure and the color registration procedure.

The central server 610 also has a database 613 comprising standardised workflows and document templates. The program 612 accesses the database 613 to ascertain the corresponding workflow for a selection of registration data (cf. step 101 of FIG. 1) and to generate instances of the document templates. These instances of the document templates are then stored in database 611, so they may be processed by the employees involved. The program 612 preferably sends corresponding bookmarks to the employees involved via the computer network 608 to simplify access to the relevant registration documents.

Alternatively, the functionality of the central servers 601 and 610 may also be achieved using a single computer or be distributed among a plurality of computers.

A product range in which products are only registered but not deregistered increases continually. To adapt the product portfolio to the current, required position, products which no longer correspond to the market conditions are deregistered again. For this purpose, a deregistration process is started which comprises the following steps, analogously to the registration process, wherein further access to the color number database is not necessary:

inputting deregistration data from a location (e.g., a deregistration location);

generating a deregistration process electronic folder for the deregistration process, wherein the electronic folder for the deregistration process is associated with the electronic folder for the product;

selecting a deregistration workflow according to the deregistration data from a quantity of predetermined deregistration workflows;

creating deregistration documents according to the selected deregistration workflow;

storing the deregistration documents in the electronic folder for the deregistration process; and

deregistering a color for the product by means of,

generating a color deregistration electronic folder for the color deregistration process, said color deregistration electronic fold being allocated to the product electronic folder,

generating color deregistration documents according to a color deregistration workflow, and

storing the color deregistration documents in the color deregistration electronic folder.

List of reference characters used in the drawing figures.

| | |
|---|---|
| color number database | 401 |
| memory sector | 402 |
| memory sector | 403 |
| color database | 501 |
| central server | 601 |
| database | 602 |
| program | 603 |
| server | 604 |
| server | 605 |
| replica | 606 |
| user interface | 607 |
| computer network | 608 |
| computer system | 609 |
| central server | 610 |
| database | 611 |
| program | 612 |
| database | 613 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for registering a product comprising:
(a) inputting registration data from a location;
(b) generating a product electronic folder for the product;
(c) generating a registration process electronic folder for the registration process, wherein the registration process electronic folder is allocated to the product electronic folder;
(d) selecting a workflow, according to the registration data, from a quantity of predetermined workflows;
(e) creating registration documents according to the selected workflow;
(f) storing the registration documents in the registration process electronic folder;
(g) registering a color for the product by means of,
(i) registering a color registration process electronic folder fothe color registration process, which is allocated to the product electronic folder,
(ii) generating color registration documents according to a color registration workflow, and
(iii) storing the color registration documents in the registration process electronic folder; and
(h) accessing a database having a plurality of locations, for purposes of assigning a color number for the registered color by means of,
(I) allocating a number space to each location, provided that a free number space remains, and
(II) carrying out the following steps to generate a new entry in the database from one of the locations:
(i) removing a number from the number space of the location,
(ii) storing the entry in the database with the number as a code, and
(iii) replacing the removed number with a number from the free number space in the number space of the location.

2. The process of claim 1 further comprising, assigning an article number for the product by accessing an inventory control system, and allocating the article number to the registration process electronic folderof the product.

3. The process of claim 1 further comprising, assigning a further article number for the product with the color by accessing an inventory control system, and allocating the further article number to the color registration process electronic folder.

4. The process of claim 1, further comprising, sending a bookmark to addressees of the registration documents to access the registration process electronic folder.

5. The process of claim 1 wherein the color number comprises first numerals to specify a color type, and second numerals for the number removed from the number space of an associated location.

6. The process of claim 5 wherein the color type is composed of a color group and a chromaticity.

7. The process of claim 1 wherein the entry in the database contains a member selected from the group consisting of color coordinates, customer information, production engineering information and combinations thereof.

8. The process of claim 1 wherein the number spaces of the locations are stored in a distributed color number database.

9. The process of claim 8 wherein the free number space is stored in at least one of the distributed databases.

10. The process of claim 8 wherein each location has a replica of the distributed color number database.

11. The process of claim 10 further comprising:
signaling the removal of the number from the number space of thelocation in the replica of the distributed color number database of this location;
cyclically interrogating the replicas of the distributed color number database as to whether a number has been removed, and
replacing the removed number with a number of the free number space in the number space of the location, and storing the replaced number in the replica of the location.

12. The process of claim 1 wherein a previously registered product is deregistered by the following steps:
inputting deregistration data from a deregistration location,
generating a deregistration process electronic folder for the deregistration process, wherein the deregistration process electronic folder is allocated to the product electronic folder;
selecting a deregistration workflow according to the deregistration data from a quantity of predetermined deregistration workflows,
creating deregistration documents according to the selected deregistration workflow;
storing the deregistration documents in the deregistration process electronic folder for the deregistration process,
deregistering a color for the product by means of,
generating a color deregistration electronic folder for the color deregistration process, said color deregistration electronic folder being allocated to the product electronic folder,
generating color deregistration documents according to a color deregistration workflow, and
storing the color deregistration documents in the color deregistration electronic folder.

13. A computer program comprising program means for carrying out the process of claim 1.

14. A computer system for registering a product comprising:
a means for inputting registration data from a location for the registration of the product, and for the registration of a color for the product;
a means for generating and storing registration documents and color registration documents;
a server;
a respective server for each location;
a color number database having a number space for each of the locations and a free number space, wherein each of the respective servers has at least one partial replica of the color number database;
a means for removing a number from the number space for each replica at a location;
a means for cyclical interrogation of the server as to whether a number has been removed from the number space of a location of a replica; and
a means for replacing a removed number with a number from the free number space in the number space of the location.

15. The computer system of claim 14, further comprising means for deregistering a previously registered product.
